(19) United States
(12) Patent Application Publication
(10) Pub. No.: US 2025/0140911 A1
(43) Pub. Date: May 1, 2025

(54) ALL-SOLID RECHARGEABLE BATTERY

(71) Applicant: SAMSUNG SDI CO., LTD., Yongin-si (KR)

(72) Inventors: Minsuk LEE, Yongin-si (KR); Jaewon KIM, Yongin-si (KR); Suyeol RYU, Yongin-si (KR); Guesung KIM, Yongin-si (KR); Young Gyoon RYU, Yongin-si (KR)

(21) Appl. No.: 18/732,918

(22) Filed: Jun. 4, 2024

(30) Foreign Application Priority Data
Oct. 30, 2023 (KR) 10-2023-0146344

(51) Int. Cl. H01M 10/0562

(52) U.S. Cl. CPC H01M 10/0562; H01M 2300/008; H01M 2300/0094

(57) ABSTRACT

An all-solid rechargeable battery includes a negative electrode; a first solid electrolyte layer on one surface of the negative electrode; a second solid electrolyte layer on one surface of the first solid electrolyte layer, and a positive electrode on one surface of the second solid electrolyte layer, wherein the first solid electrolyte layer includes rounded first solid electrolyte particles, and the first solid electrolyte layer has a first thickness of 2 μm or less.

### CROSS-REFERENCE TO RELATED APPLICATION

This application claims priority to and the benefit of Korean Patent Application No. 10-2023-0146344 filed in the Korean Intellectual Property Office on Oct. 30, 2023, the entire contents of which are incorporated herein by reference.

### BACKGROUND

### 1. Field

Embodiments relate to an all-solid rechargeable battery.

### 2. Description of the Related Art

Recently, in response to industrial demands, the development of batteries with high energy density and safety has been actively conducted. Lithium-ion batteries may be utilized not only in the fields of information-related devices and communication devices, but also in the automobile field. In the automobile field, safety is especially important because it involves life.

Some lithium-ion batteries currently may use electrolytes containing flammable organic solvents, so there is a possibility of overheating and fire in the event of a short circuit. In this regard, an all-solid rechargeable battery using a solid electrolyte instead of an electrolyte has been considered.

All-solid rechargeable batteries may greatly reduce the possibility of fire or explosion, even in the event of a short circuit, by not using flammable organic solvents. Therefore, the all-solid batteries may greatly increase safety compared to lithium-ion batteries using electrolytes.

The above information disclosed in this Background section is only for enhancement of understanding of the background of the described technology and therefore it may contain information that does not form the prior art that is already known in this country to a person of ordinary skill in the art.

### SUMMARY

The embodiments may be realized by providing an all-solid rechargeable battery including a negative electrode; a first solid electrolyte layer on one surface of the negative electrode; a second solid electrolyte layer on one surface of the first solid electrolyte layer; and a positive electrode on one surface of the second solid electrolyte layer, wherein the first solid electrolyte layer includes rounded first solid electrolyte particles, and the first solid electrolyte layer has a first thickness of 2 μm or less.

The rounded first solid electrolyte particles may have a spherical shape, an oval shape, or a disc shape.

The second solid electrolyte layer may include second solid electrolyte particles, and the second solid electrolyte particles may have a sharp shape.

The second solid electrolyte particles may be in a powder form and may be prepared by dry process.

The rounded first solid electrolyte particles may be in a powder form and may be prepared by a wet process.

The second solid electrolyte layer may include second solid electrolyte particles, and the second solid electrolyte layer may have a second thickness of 3 μm to 5 μm.

The first thickness may be 0.5 μm to 1 μm.

The rounded first solid electrolyte particles may have an average particle diameter (D50) of 10 nm to 10 μm, and the first solid electrolyte layer may have a thickness of 50 μm to 100 μm before pressure is applied thereto to form the first solid electrolyte layer having the first thickness of 2 μm or less.

The second solid electrolyte layer may include second solid electrolyte particles, the second solid electrolyte particles may have an average particle diameter (D50) of 10 nm to 10 μm, and the second solid electrolyte layer may have a thickness of 25 μm to 50 μm before pressure is applied thereto.

The second solid electrolyte layer may have a second thickness that is greater than the first thickness.

### BRIEF DESCRIPTION OF THE DRAWINGS

Features will be apparent to those of skill in the art by describing in detail exemplary embodiments with reference to the attached drawings in which:

FIG. 1 is a longitudinal cross-sectional view showing an all-solid rechargeable battery according to an embodiment.

FIG. 2 is a longitudinal cross-sectional view showing the formation of a lithium metal layer in an all-solid rechargeable battery according to an embodiment.

FIG. 3 is a longitudinal cross-sectional view showing an all-solid rechargeable battery according to the first embodiment of the present disclosure.

FIG. 4 is a longitudinal cross-sectional view showing a state before pressure is applied to the all-solid rechargeable battery.

FIG. 5 is a longitudinal cross-sectional view showing the state of the all-solid rechargeable battery of FIG. 4 after pressure is applied.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise”, and variations such as “comprises” or “comprising”, will be understood to imply the inclusion of stated elements but not the exclusion of any other elements.

In the drawings, the thickness of layers and regions are exaggerated for clarity. Like reference numerals designate like elements throughout the specification. It will be understood that when an element such as a layer, film, region, or substrate is referred to as being “on” or “above” another element, it can be “directly on” the other element or intervening elements may also be present. In contrast, when an element is referred to as being “directly on” another element, there are no intervening elements present.

The term “layer” includes a construction having a shape formed on a part of a region, in addition to a construction having a shape formed on an entire region. Here, “or” is not interpreted in an exclusive sense, and for example, “A or B” is interpreted as including A, B, A+B, or the like.

Positive Electrode for all-Solid Rechargeable Battery

A positive electrode for an all-solid rechargeable battery may include a current collector and a positive electrode active material layer on the current collector. In an implementation, the positive electrode active material layer may include, e.g., a positive electrode active material, a sulfide solid electrolyte, a fluorinated resin binder, and vanadium oxide.

The positive electrode for the all-solid rechargeable battery may be prepared by applying a positive electrode composition (containing a positive electrode active material, a sulfide solid electrolyte, a fluorinated resin binder, and vanadium oxide) to a current collector, followed by drying and rolling.

The positive electrode composition may become strongly alkaline due to residual lithium, e.g., LiOH or other components, which could cause gelation or aggregation of the fluorinated resin binder. According to an embodiment, by adding vanadium oxide, the gelation of the fluorinated resin binder may be suppressed, and thus the viscosity of the positive electrode composition may be maintained, ensuring processability. In addition, there may be no need to use a neutralizing agent or the like, so degradation of the sulfide solid electrolyte (e.g., due to the neutralizing agent) may be prevented, thereby improving the performance of the all-solid rechargeable battery.

### Vanadium Oxide

The vanadium oxide may be a component that is insoluble in the solvent of the positive electrode composition, controlling the strong alkalinity of the positive electrode composition to help prevent the gelation of the fluorinated resin binder, while simultaneously suppressing the thermal degradation of the sulfide solid electrolyte to enhance the ionic conductivity of the positive electrode. Vanadium oxide may help control the pH through physical or chemical reactions with the —OH group in the strong alkali state of the positive electrode composition, thereby suppressing the gelation of the fluorinated resin binder. Compared to other transition metal oxides (e.g., titanium oxide or tungsten oxide), the vanadium oxide may have a more excellent ability to control basicity and suppress gelation of fluorinated resin binders, and may have low reactivity with sulfide solid electrolytes. In addition, it is possible to help improve the ionic conductivity of the all-solid rechargeable battery by suppressing the degradation of the sulfide solid electrolyte and improve the overall performance.

The vanadium oxide may include, e.g., V₂O₃, VO₂, V₂O₄, V₂O₅, or combination thereof. In an implementation, the vanadium oxide may be included in an amount of 0.01 wt % to 5 wt %, based on a total weight of the positive electrode active material layer, e.g., 0.05 wt % to 5 wt %, 0.1 wt % to 5 wt %, 0.5 wt % to 5 wt %, or 0.5 wt % to 3 wt %. Maintaining the amount of the vanadium oxide within the above ranges may help ensure that the viscosity of the positive electrode composition may be appropriately maintained without reducing capacity, thereby improving processability and improving ionic conductivity of the positive electrode.

In an implementation, the positive electrode composition may be coated on the current collector while the positive electrode composition is dispersed by adding vanadium oxide to the positive electrode composition. Therefore, the vanadium oxide may be dispersed in the prepared positive electrode active material layer. This may be distinguished from the form in which vanadium oxide is coated on the surface of the positive electrode active material or sulfide solid electrolyte.

In an implementation, the vanadium oxide may be pentavalent vanadium (V) oxide. In an implementation, the melting point of the vanadium oxide may be 1,000° C. or lower, e.g., 600° C. to 800° C., or 650° C. to 690° C. The pentavalent vanadium oxide may be excellent for suppressing gelation of the fluorinated resin binder in the positive electrode and may be advantageous for improving the overall performance of the battery.

In an implementation, the vanadium oxide may be in the form of particles. The average particle diameter (D50) of the vanadium oxide may be 10 nm to 10 μm, e.g., 10 nm to 5 μm, 10 nm to 3 μm, 50 nm to 1 μm, 50 nm to 500 nm, or 500 nm to 1 μm. Vanadium oxide with these physical properties may be suitable for addition to the positive electrode composition and may help effectively suppress gelation of the positive electrode composition without adversely affecting the positive electrode. If the particle diameter of vanadium oxide were to be too small, it may not be properly dispersed within the positive electrode, blocking the passage of electrons and ions, which could deteriorate battery performance, or may not sufficiently perform the role of suppressing gelation of the binder. If the particle diameter of vanadium oxide were to be too large, it could block the passage of electrons and ions, deteriorating battery performance.

### Fluorinated Resin Binder

The fluorinated resin binder may be a resin binder containing fluorine, e.g., polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polytetrafluoroethylene, or a combination thereof.

The weight average molecular weight of the fluorinated resin binder may be, e.g., about 50 kDa to 5,000 kDa, or 100 kDa to 2,000 kDa. In an implementation, the glass transition temperature of the fluorinated resin binder may be −10° C. or lower, and the melting point may be 100° C. or higher. The melting viscosity of the fluorinated resin binder may be about 10 kP to 50 kP. In an implementation, the fluorinated resin binder may be in the form of particles and the average particle diameter of the fluorinated resin binder may be, e.g., about 50 nm to 200 μm. A fluorinated resin binder with these properties may help achieve excellent adherence, even if only a small amount is added to the positive electrode composition and may increase battery durability without adversely affecting battery performance.

The fluorinated resin binder may be included in an amount of 0.1 wt % 10 wt % based on the total weight of the positive electrode active material layer, e.g., 0.1 wt % to 8 wt %, 0.1 wt % to 6 wt %, 0.1 wt % to 5 wt %, 0.5 wt % to 4 wt %, or 1 wt % to 3 wt %. Maintaining the amount of the fluorinated resin binder within the above ranges may help ensure that excellent adherence may be achieved without adversely affecting the positive electrode.

### Positive Electrode Active Material

The positive electrode active material may be a suitable material for all-solid rechargeable batteries. In an implementation, the positive electrode active material may be a compound capable of reversible intercalation and deintercalation of lithium, e.g., a compound represented by any of the following chemical formulas:

LiₐA_{1-b}X_{b}D′₂ (0.90≤a≤1.8, 0≤b≤0.5);

LiₐA_{1-b}X_{b}O_{2-c}D′_{c} (0.90≤a≤1.8, 0≤b≤0.5, 0≤c≤0.05);

LiₐE_{1-b}X_{b}O_{2-c}D′_{c} (0.90≤a≤1.8, 0≤b≤0.5, 0≤c≤0.05);

LiₐE_{2-b}X_{b}O_{4-c}D′_{c} (0.90≤a≤1.8, 0≤b≤0.5, 0≤c≤0.05);

LiₐNi_{1-b-c}Co_{b}X_{c}D′_{α} (0.90≤a≤1.8, 0≤b≤0.5, 0≤c≤0.5, 0<α≤2);

LiₐNi_{1-b-c}Co_{b}X_{c}O_{2-α}T_{α} (0.90≤a≤1.8, 0≤b≤0.5, 0≤c≤0.05, 0<α≤2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D′_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤18, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂GbO₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂PO₄₃ (0≤f≤2);

Li_{(3-f)}Fe₂PO₄₃ (0≤f≤2);

LiₐFePO₄ (0.90≤a≤1.8).

In the above Chemical Formulas, A may be, e.g., Ni, Co, Mn, or a combination thereof; X may be, e.g., Al, Ni, Co, Mn, Cr, Fe, Mg, Sr, V, a rare earth element, or a combination thereof; D′ may be, e.g., O, F, S, P, or a combination thereof; E may be, e.g., Co, Mn, and a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, and a combination thereof; Z may be, e.g., Cr, V, Fe, Sc, Y, or a combination thereof; and J may be, e.g., V, Cr, Mn, Co, Ni, Cu, or a combination thereof.

The positive electrode active material may be, e.g., lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate (LFP).

The positive electrode active material may include, e.g., a lithium nickel oxide represented by Chemical Formula 1 below, a lithium cobalt oxide represented by Chemical Formula 2 below, a lithium iron phosphate compound represented by Chemical Formula 3 below, or a combination thereof.

Liₐ₁Niₓ₁M¹_{y1}M²_{1-x1-y1}O₂ [Chemical Formula 1]

In the Chemical Formula 1, 0.9≤a1≤1.8, 0.3≤x1≤1, 0≤y1≤0.7, and M¹ and M² may each independently be Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In the Chemical Formula 2, 0.95a2≤1.8, 0.6≤x2≤1, and M³ may be Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₁₋ₓ₃PO₄ [Chemical Formula 3]

In the Chemical Formula 3, 0.95a3≤1.8, 0.6≤x3≤1, and M⁴ may be Al, B, Ba, Ca, Ce, Co, Cr, Cu, F, Fe, Mg, Mn, Mo, Nb, P, S, Si, Sr, Ti, V, W, or Zr.

The average particle diameter (D50) of the positive electrode active material may be 1 μm to 25 μm, e.g., 3 μm to 25 μm, 5 μm to 25 μm, 5 μm to 20 μm, 8 μm to 20 μm, or 10 μm to 18 μm. The positive electrode active material having these particle diameter ranges may be harmoniously mixed with other components within the positive electrode active material layer and may achieve high-capacity and high energy density.

The positive electrode active material may be in the form of secondary particles made by agglomerating a plurality of primary particles, or may be in the form of single particles. In an implementation, the positive electrode active material may be spherical or close to a spherical shape, or may be polyhedral or amorphous.

### Sulfide Solid Electrolyte

The sulfide solid electrolyte may include, e.g., Li₂S—P₂S₅, Li₂S—P₂S₅—LiX (where X is a halogen element, e.g. I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m, n are each an integer, and Z is Ge, Zn or Ga), Li₂S—GeS₂, Li₂S—SiS₂—Li₃PO₄, Li₂S—SiS₂—LiₚMO_{q} (where p, q are integers, and M is P, Si, Ge, B, Al, Ga or In), or a combination thereof.

The sulfide solid electrolyte may be obtained, e.g., by mixing Li₂S and P₂S₅ at a molar ratio of 50:50 to 90:10, or 50:50 to 80:20, and optionally heat-treating the mixture. Within the above mixing ratio ranges, a sulfide solid electrolyte having excellent ionic conductivity may be prepared. In an implementation, ion conductivity may be further improved by adding SiS₂, GeS₂, B₂S₃, or the like, as other components.

Mechanical milling or solution method may be applied as a method of mixing sulfur-containing raw materials to prepare a sulfide solid electrolyte. Mechanical milling is a method of mixing the starting materials into fine particles by placing the starting materials and a ball mill in a reactor and stirring strongly. In the solution method, a solid electrolyte may be obtained as a precipitate by mixing the starting materials in a solvent. In addition, heat treatment may be performed after mixing, and the crystals of the solid electrolyte may become stronger and ionic conductivity may be improved. In an implementation, a sulfide solid electrolyte may be prepared by mixing sulfur-containing raw materials and heat-treating them two or more times. In this case, a sulfide solid electrolyte with high ionic conductivity and robustness may be prepared.

In an implementation, the sulfide solid electrolyte particles may include argyrodite-type sulfide. The argyrodite-type sulfide may be represented, e.g., by the chemical formula LiₐM_{b}P_{c}S_{d}Aₑ (where a, b, c, d, and e are all 0 to 12, M is Ge, Sn, Si, or a combination of these, and A is F, Cl, Br, or I). In an implementation, the argyrodite-type sulfide may be represented by the chemical formula Li₇₋ₓPS₆₋ₓAₓ (where x is 0.2 to 1.8, and A is F, Cl, Br, or I). In an implementation, the argyrodite-type sulfide may be, e.g., Li₃PS₄, Li₂P₃S₁₁, Li₂PS₆, Li₆PS₅Cl, Li₆PS₅Br, Li_{5.8}PS_{4.8}Cl_{1.2}, Li_{6.2}PS_{5.2}Br_{0.8}, or the like.

The sulfide solid electrolyte particle containing the argyrodite-type sulfide may have a high ionic conductivity close to the range of 10⁻⁴ to 10⁻² S/cm, which is the ionic conductivity of a typical liquid electrolyte at room temperature, and may form a tight or strong bond between the positive electrode active material and the solid electrolyte without causing a decrease in ionic conductivity, and further, may form a tight interface between the electrode layer and the solid electrolyte layer. All-solid batteries containing the argyrodite-type sulfide may have improved battery performance such as rate characteristics, coulombic efficiency, and lifespan characteristics.

The argyrodite-type sulfide solid electrolyte may be prepared, e.g., by mixing lithium sulfide, phosphorus sulfide, and selectively lithium halide. After mixing them, heat treatment may be performed. The heat treatment may include, e.g., two or more heat treatment steps.

The average particle diameter (D50) of the sulfide solid electrolyte particles according to an embodiment may be 5.0 μm or less, e.g., 0.1 μm to 5.0 μm, 0.1 μm to 4.0 μm, 0.1 μm to 3.0 μm, 0.5 μm to 2.0 μm, or 0.1 μm to 1.5 μm. In an implementation, the sulfide solid electrolyte particles may be small particles having an average particle diameter (D50) of 0.1 μm to 1.0 μm depending on the position or purpose of use, or large particles having an average particle diameter (D50) of 1.5 μm to 5.0 μm.

Sulfide solid electrolyte particles in these particle diameter ranges may effectively penetrate between solid particles in a battery, and may have excellent contact with the electrode active material and connectivity between solid electrolyte particles. The average particle diameter of the sulfide solid electrolyte particles may be measured from a microscope image, e.g., by measuring the size of about 20 particles from a scanning electron microscope image to obtain a particle size distribution, and then calculating the D50 from it.

The amount of the solid electrolyte in the positive electrode for an all-solid battery may be 0.5 wt % to 35 wt %, e.g., 1 wt % to 35 wt %, 5 wt % to 30 wt %, 8 wt % to 25 wt %, or 10 wt % to 20 wt %. This is the amount relative to the total weight of the components in the positive electrode, e.g., the amount relative to the total weight of the positive electrode active material layer.

In an implementation, the positive electrode active material layer may include a positive electrode active material in an amount of 50 wt % to 99.35 wt %, based on the total weight of the positive electrode active material layer, a sulfide solid electrolyte in an amount of 0.5 wt % to 35 wt %, a fluorinated resin binder in an amount of 0.1 wt % to 10 wt %, and a vanadium oxide in an amount of 0.05 wt % to 5 wt %. Within these amount ranges, the positive electrode for an all-solid rechargeable battery may maintain high adherence while maintaining high-capacity and high ionic conductivity, and the viscosity of the positive electrode composition may be maintained at an appropriate level, thereby improving processability.

### Conductive Material

The positive electrode active material layer may further include a conductive material. The conductive material may provide conductivity to an electrode, and may include, e.g., a carbon material such as natural graphite, artificial graphite, carbon black, acetylene black, ketjen black, a carbon fiber, a carbon nanotube, or the like; a metal material of a metal powder or a metal fiber including copper, nickel, aluminum, silver, or the like; a conductive polymer such as a polyphenylene derivative; or a combination thereof.

The conductive material may be included in an amount of 0.1 wt % to 5 wt %, or 0.1 wt % to 3 wt %, based on the total weight of each component of the positive electrode for an all-solid battery, or based on the total weight of the positive electrode active material layer. Within the above amount ranges, the conductive material may help improve electrical conductivity without deteriorating battery performance.

In an implementation, the positive electrode active material layer may further include a conductive material, and the positive electrode active material layer may include 45 wt % to 99.25 wt % of the positive electrode active material, 0.5 wt % to 35 wt % of a sulfide solid electrolyte, 0.1 wt % to 10 wt % of a fluorinated resin binder, 0.05 wt % to 5 wt % of vanadium oxide, and 0.1 wt % to 5 wt % of a conductive material, based on the total weight of the positive electrode active material layer.

In an implementation, the positive electrode for a lithium rechargeable battery may further include an oxide inorganic solid electrolyte in addition to the solid electrolyte described above. The oxide inorganic solid electrolyte may include, e.g., Li₁₊ₓTi₂₋ₓAl PO₄₃ (LTAP) (0≤x≤4), Li_{1+x+y}AlₓTi₂₋ₓSi_{y}P_{3-y}O¹² (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics (Li₃₊ₓLa₃M₂O₁₂ (M=Te, Nb, or Zr; where x is an integer 1 to 10), or a combination thereof.

### All-Solid Rechargeable Battery

An all-solid rechargeable battery may include the above-described positive electrode and negative electrode, and a solid electrolyte layer between the positive electrode and the negative electrode. The all-solid rechargeable battery may be an all-solid battery or an all-solid lithium rechargeable battery.

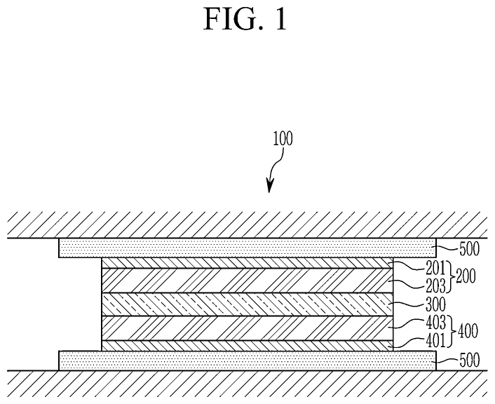

FIG. 1 is a cross-sectional view showing an all-solid rechargeable battery according to an embodiment. Referring to FIG. 1, an all-solid battery 100 may be a structure in which an electrode assembly is stacked, having a negative electrode 400 (including a negative electrode current collector 401 and a negative electrode active material layer 403), a solid electrolyte layer 300, and a positive electrode 200 (including a positive electrode active material layer 203 and a positive electrode current collector 201), and may be accommodated in a case, e.g., a pouch. In an implementation, the all-solid battery 100 may further include an elastic layer 500 on the outside of at least one of the positive electrode 200 and the negative electrode 400. In an implementation, as illustrated in FIG. 1, one electrode assembly may include the negative electrode 400, the solid electrolyte layer 300, and the positive electrode 200, or an all-solid battery may also be prepared by stacking two or more electrode assemblies.

### Negative Electrode

In an implementation, a negative electrode for an all-solid battery may include a current collector and a negative electrode active material layer on the current collector. The negative electrode active material layer may include a negative electrode active material and may further include a binder, a conductive material, or a solid electrolyte.

The negative electrode active material may include a material capable of reversible intercalation/deintercalation of lithium ion, lithium metal, an alloy of lithium metal, a material capable of doping and dedoping lithium, or a transition metal oxide.

The material capable of reversibly intercalating/deintercalating lithium ions is a carbon negative electrode active material, and may include, e.g., crystalline carbon, amorphous carbon, or a combination thereof. Examples of the crystalline carbon may be amorphous, sheet, flake, spherical or fiber shaped natural graphite or artificial graphite. Examples of the amorphous carbon may be a soft carbon or hard carbon, mesophase pitch carbide, fired coke, or the like.

The lithium metal alloy may be an alloy of lithium and, e.g., Na, K, Rb, Cs, Fr, Be, Mg, Ca, Sr, Si, Sb, Pb, In, Zn, Ba, Ra, Ge, Al, or Sn.

The material capable of doping and dedoping lithium may be a Si negative electrode active material or a Sn negative electrode active material. The Si negative electrode active material may include silicon, silicon-carbon composite, SiOx (0<x<2), or a Si-Q alloy (wherein Q is an alkali metal, alkaline earth metal, a Group 13 element, a Group 14 element, a Group 15 element, a Group 16 element, a transition metal, a rare earth element, or a combination thereof, but not Si). The Sn negative electrode active materials may include Sn, SnO₂, or Sn—R alloy (where R is an alkali metal, an alkaline-earth metal, a Group 13 element, a Group 14 element, a Group 15 element, a Group 16 element, a transition metal, a rare earth element, or a combination thereof, but not Sn), and the like, and at least one of these materials may be mixed with SiO₂. In an implementation, the elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

In an implementation, the silicon-carbon composite may be a silicon-carbon composite including a core containing crystalline carbon and silicon particles and an amorphous carbon coating layer on the surface of the core. The crystalline carbon may be artificial graphite, natural graphite, or a combination thereof. The amorphous carbon precursor may be coal pitch, mesophase pitch, petroleum pitch, coal oil, petroleum heavy oil, or polymer resin such as phenol resin, furan resin, and polyimide resin, or the like. In an implementation, the amount of silicon may be 10 wt % to 50 wt % based on the total weight of the silicon-carbon composite. In an implementation, the amount of the crystalline carbon may be 10 wt % to 70 wt % based on the total weight of the silicon-carbon composite, and the amount of the amorphous carbon may be 20 wt % to 40 wt % based on the total weight of the silicon-carbon composite. In an implementation, the thickness of the amorphous carbon coating layer may be 5 nm to 100 nm.

The average particle diameter (D50) of the silicon particles may be 10 nm to 20 μm, e.g., 10 nm to 500 nm. The silicon particles may exist in an oxidized form, and in this case, the atomic amount ratio of Si:O in the silicon particles, which indicates the degree of oxidation, may be 99:1 to 33:67. The silicon particles may be SiOₓ particles, and in this case, the x range in SiOx may be greater than 0 and less than 2. Here, the average particle diameter (D50) is measured with a particle size analyzer using a laser diffraction method and means the diameter of particles with a cumulative volume of 50% by volume in the particle size distribution.

The Si negative electrode active material or Sn negative electrode active material may be used by mixing with a carbon negative electrode active material. A mixing ratio of the Si negative electrode active material or Sn negative electrode active material; and the carbon negative electrode active material may be 1:99 to 90:10 by weight.

The amount of the negative electrode active material in the negative electrode active material layer may be 95 wt % to 99 wt %, based on the total weight of the negative electrode active material layer.

In an implementation, the negative electrode active material layer may further include a binder or a conductive material. The amount of the binder in the negative electrode active material layer may be 1 wt % to 5 wt %, based on the total weight of the negative electrode active material layer. In an implementation, a conductive material may be further included, and the negative electrode active material layer may include 90 wt % to 98 wt % of the negative electrode active material, 1 wt % to 5 wt % of the binder, and 1 wt % to 5 wt % of the conductive material.

The binder may help adhere the negative electrode active material particles to each other and adhere the negative electrode active material to the current collector. The binder may include a non-water-soluble binder, a water-soluble binder, or a combination thereof.

The non-water-soluble binder may include, e.g., polyvinylchloride, carboxylated polyvinylchloride, polyvinylfluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamidoimide, polyimide, or a combination thereof.

The water-soluble binder may be a rubber binder or polymer resin binder. The rubber binder may include styrene-butadiene rubber, acrylated styrene-butadiene rubber, acrylonitrile-butadiene rubber, acrylic rubber, butyl rubber, fluorine rubber, or a combination thereof. The polymer resin binder may include polyethylene oxide, polyvinylpyrrolidone, polyepichlorohydrin, polyphosphazene, polyacrylonitrile, ethylene propylene diene copolymer, polyvinylpyridine, chlorosulfonated polyethylene, latex, polyesterresin, acrylresin, phenolresin, epoxy resin, polyvinyl alcohol, or a combination thereof.

In an implementation, a water-soluble binder may be used as the negative electrode binder, and a thickener capable of providing viscosity may be used together. In an implementation, the thickener may include, e.g., a cellulose compound. The cellulose compound may include carboxymethyl cellulose, hydroxypropylmethyl cellulose, methyl cellulose, alkali metal salts thereof, or a combination thereof. The alkali metals may be Na, K, or Li. The amount of the thickener used may be 0.1 to 3 parts by weight based on 100 parts by weight of the negative electrode active material.

The conductive material may provide conductivity to an electrode, and may include, e.g., a carbon material such as natural graphite, artificial graphite, carbon black, acetylene black, ketjen black, a carbon fiber, a carbon nanotube, or the like; a metal material of a metal powder or a metal fiber including copper, nickel, aluminum, silver, or the like; a conductive polymer such as a polyphenylene derivative; or a combination thereof.

The negative electrode current collector may include, e.g., copper foil, nickel foil, stainless steel foil, titanium foil, nickel foam, copper foam, a polymer substrate coated with a conductive metal, or a combination thereof.

In an implementation, the negative electrode for an all-solid battery may be a precipitated negative electrode. The precipitated negative electrode refers to a negative electrode that does not contain a negative electrode active material during battery assembly, but metals such as lithium are precipitated, which serve as the negative electrode active material.

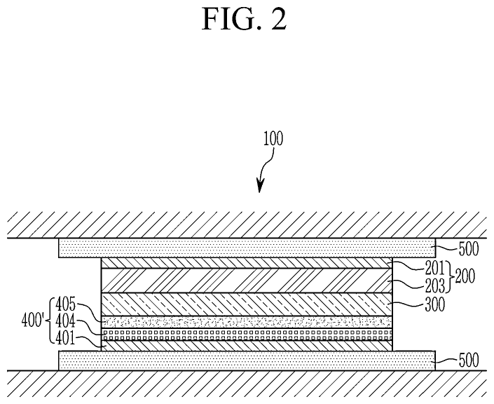

FIG. 2 is a schematic cross-sectional view of an all-solid rechargeable battery including a precipitated negative electrode according to an embodiment. Referring to FIG. 2, a precipitated negative electrode 400′ may include the negative electrode current collector 401 and a negative electrode coating layer 405 on the current collector. An all-solid battery with the precipitated negative electrode 400′ may begin initial charging in a state where there is no negative electrode active material, and during charging, high-density lithium metal may be deposited between the negative electrode current collector 401 and the negative electrode coating layer 405, forming a lithium metal layer 404, which may serve the role of the negative electrode active material.

Accordingly, in an all-solid battery that has been charged at least once, the precipitated negative electrode 400′ may include the negative electrode current collector 401, the lithium metal layer 404 on the current collector, and the negative electrode coating layer 405 on the metal layer. The lithium metal layer 404 refers to a layer in which lithium metal or the like is deposited during the charging process of the battery, and may be referred to as a metal layer or a negative electrode active material layer.

The negative electrode coating layer 405 may include metal, carbon material, or a combination thereof that acts as a catalyst.

The metal may include, e.g., gold, platinum, palladium, silicon, silver, aluminum, bismuth, tin, zinc, or a combination thereof, or may include one of these or various types of alloys. In an implementation, the metal may be in particle form, and the average particle diameter (D50) of the metal may be about 4 μm or less, e.g., 10 nm to 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

In an implementation, the negative electrode coating layer 405 may include both the metal and the carbon material, and the mixing ratio of the metal and the carbon material may be, e.g., 1:10 to 2:1 by weight. In this case, the precipitation of lithium metal may be effectively promoted and the characteristics of the all-solid battery may be improved. In an implementation, the negative electrode coating layer 405 may include a carbon material on which a catalyst metal is supported, or may include a mixture of metal particles and carbon material particles.

In an implementation, the negative electrode coating layer 405 may include the metal and amorphous carbon, and in this case, it is possible to effectively promote precipitation of lithium metal.

The negative electrode coating layer 405 may further include a binder, and the binder may be a conductive binder. In an implementation, the negative electrode coating layer 405 may further include an additive, e.g., fillers, dispersants, or ion conductive materials.

The thickness of the negative electrode coating layer 405 may be, e.g., 100 nm to 20 μm, or 500 nm to 10 μm, or 1 μm to 5 μm.

In an implementation, the precipitated negative electrode 400′ may further include a thin film on the surface of the current collector, e.g., between the current collector and the negative electrode coating layer. The thin film may contain an element capable of forming an alloy with lithium. Elements capable of forming an alloy with lithium may include, e.g., gold, silver, zinc, tin, indium, silicon, aluminum, bismuth, or the like, and may include one type or various types of alloys. The thin film may further planarize the precipitation form of the lithium metal layer 404 and further improve the characteristics of the all-solid battery. The thin film may be formed by, e.g., vacuum deposition, sputtering, or plating methods. The thickness of the thin film may be, e.g., 1 nm to 500 nm.

### Solid Electrolyte Layer

The solid electrolyte layer 300 may include a sulfide solid electrolyte, an oxide solid electrolyte, or the like. The specific details of the sulfide solid electrolyte and the oxide solid electrolyte are as described above.

In an implementation, the solid electrolyte included in the positive electrode 200 and the solid electrolyte included in the solid electrolyte layer 300 may include the same compound or different compounds. In an implementation, both the positive electrode 200 and the solid electrolyte layer 300 may contain an argyrodite-type sulfide solid electrolyte, and the overall performance of the all-solid rechargeable battery may be improved. In an implementation, both the positive electrode 200 and the solid electrolyte layer 300 may include the above-described coated solid electrolyte, and the all-solid rechargeable battery may implement high-capacity and high energy density while realizing excellent initial efficiency and lifespan characteristics.

In an implementation, the average particle diameter (D50) of the solid electrolyte included in the positive electrode 200 may be smaller than the average particle diameter (D50) of the solid electrolyte included in the solid electrolyte layer 300. In this case, overall performance may be improved by maximizing the energy density of the all-solid battery and increasing the mobility of lithium ions. In an implementation, the average particle diameter (D50) of the solid electrolyte included in the positive electrode 200 may be 0.1 μm to 1.0 μm, or 0.1 μm to 0.8 μm, and the average particle diameter (D50) of the solid electrolyte included in the solid electrolyte layer 300 may be between 1.5 μm and 5.0 μm, or between 2.0 μm and 4.0 μm, or between 2.5 μm and 3.5 μm. Within these particle diameter ranges, the energy density of the all-solid rechargeable battery may be maximized and the transfer of lithium ions may be facilitated, thereby suppressing resistance and thus improving the overall performance of the all-solid rechargeable battery. Here, the average particle diameter (D50) of the solid electrolyte may be measured through a particle size analyzer using a laser diffraction method. Alternatively, the D50 value may be calculated by selecting about 20 particles from a microscope photo such as a scanning electron microscope, measuring the particle size, and obtaining the particle size distribution.

The solid electrolyte layer may further include a binder in addition to the solid electrolyte. In an implementation, the binder may include styrene butadiene rubber, polytetrafluoroethylene, polyvinylidene fluoride, polyethylene, acrylate polymer, or a combination thereof, or other suitable binder. The acrylate polymer may be, e.g., butyl acrylate, polyacrylate, polymethacrylate, or a combination thereof.

The solid electrolyte layer may be formed by adding a solid electrolyte to a binder solution, coating it onto a base film, and drying it. The solvent for the binder solution may be isobutyryl isobutyrate, xylene, toluene, benzene, hexane, or a combination thereof.

The thickness of the solid electrolyte layer may be, e.g., 10 μm to 150 μm.

In an implementation, the solid electrolyte layer may further include an alkali metal salt, an ionic liquid, or a conductive polymer.

The alkali metal salt may be, e.g., a lithium salt. The concentration of lithium salt in the solid electrolyte layer may be 1M or more, e.g., 1M to 4M. In this case, the lithium salt may help improve ion conductivity by improving the lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro (oxalato) borate (LiDFOB), lithium bis(trifluoro methanesulfonyl)imide, LiTFSI, LiN(SO₂CF₃)₂), lithium bis(fluorosulfonyl)imide, LiN(SO₂F)₂), LiCF₃SO₃, LiAsF₆, LiSbF₆, LiClO₄, or mixtures thereof.

In an implementation, the lithium salt may be an imide lithium salt, e.g., lithium bis(trifluoro methanesulfonyl)imide, LiTFSI, LiN(SO₂CF₃)₂), lithium bis(fluorosulfonyl)imide, LiFSI, or LiN(SO₂F)₂). The lithium salt may help maintain or improve ionic conductivity by maintaining appropriate chemical reactivity with ionic liquid.

The ionic liquid refers to a salt or room temperature molten salt that has a melting point below room temperature and is therefore liquid at room temperature, including only ions.

The ionic liquid may be a compound including a positive ion, e.g., ammonium, pyrrolidinium, pyridinium, pyrimidinium, imidazolium, piperidinium, pyrazolium, oxazolium, pyridazinium, phosphonium, sulfonium, triazolium, or mixtures thereof, and a negative ion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)2N⁻; (C₂F₅SO₂)(CF₃SO₂)N⁻, or (CF₃SO₂)₂N⁻.

The ionic liquid may include, e.g., N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. A solid electrolyte layer that satisfies the above ranges may help maintain or improve ionic conductivity by improving the electrochemical contact area with the electrode. Accordingly, the energy density, discharge capacity, and rate characteristics of the all-solid battery may be improved.

The all-solid battery may be a unit cell having a structure of positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid battery may be, e.g., coin-shaped, button-shaped, sheet-shaped, stacked-shaped, cylindrical, flat, or the like. In an implementation, the all-solid battery may also be applied to large batteries used in electric vehicles, or the like. In an implementation, the all-solid battery may also be used in hybrid vehicles such as plug-in hybrid electric vehicles (PHEV). In an implementation, the all-solid battery may be used in fields that require large amounts of power storage, for example, electric bicycles or power tools.

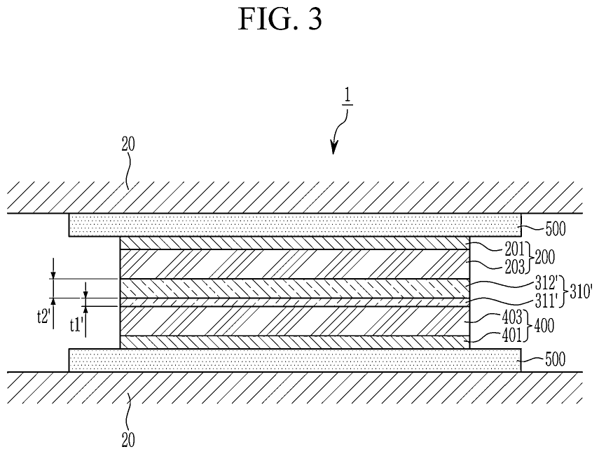

FIG. 3 is a longitudinal cross-sectional view showing an all-solid rechargeable battery according to the first embodiment of the present disclosure. Referring to FIG. 3, an all-solid rechargeable battery 1 of the first embodiment may include a negative electrode 400, a solid electrolyte layer 310′, the positive electrode 200, and the elastic layer 500. The all-solid rechargeable battery 1 of the first embodiment may be referred to as a mono-cell including a single-sided electrode plate.

The positive electrode 200 may include the positive electrode active material layer 203 produced by slurry coating or bonding a solvent-free active material to one surface of the positive electrode current collector 201. The negative electrode 400 may include the negative electrode active material layer 403 on the negative electrode current collector 401.

The solid electrolyte layer 310′ may be formed as a film by directly coating the solid electrolyte film on the negative electrode active material layer 403. In an implementation, the solid electrolyte layer 310′ includes a first solid electrolyte layer 311′ and a second solid electrolyte layer 312′, e.g., stacked on each other.

The first solid electrolyte layer 311′ may be formed as a film by directly coating first solid electrolyte particles on the negative electrode active material layer 403. The second solid electrolyte layer 312′ may be formed as a film by directly coating second solid electrolyte particles on the first solid electrolyte layer 311′. The positive electrode 200 (including the positive electrode active material layer 203 and the positive electrode current collector 201) may be stacked on the second solid electrolyte layer 312′.

Thus, the all-solid-state battery 1 of the first embodiment may form a stacked structure of the negative electrode current collector 401 and the negative electrode active material layer 403 of the negative electrode 400, the first solid electrolyte layer 311′ and the second solid electrolyte layer 312′ of the solid electrolyte layer 310′, and the positive electrode active material layer 203 and the positive electrode current collector 201 of the positive electrode 200.

The elastic layer 500 may be on at least one side of the positive electrode 200 and the negative electrode 400, e.g., the elastic layer 500 may be on each side of the positive electrode 200 and the negative electrode 400. In an implementation, the negative electrode 400 may be a Li ion precipitation type, Li ions may pass through the solid electrolyte layer 310′ from the positive electrode 200 and precipitate on the negative electrode 400 during charging, and may be released and move to the positive electrode 200 during discharging.

The elastic layer 500 may help provide the planarity between the negative electrode 400 and the first solid electrolyte layer 311′ in responding to the expansion and contraction caused by the Li precipitation and dissolution of the negative electrode 400 during charging and discharging with buffering and elastic force, and may help provide planarity between the second solid electrolyte layer 312′ and the positive electrode 200.

In an implementation, the elastic layer 500 may be on both sides of the laminate of the negative electrode 400/solid electrolyte layer 310′/positive electrode 200 and may be supported by an end plate 20. The elastic layer 500 may be on the outermost layer of the laminate and may provide buffering and elastic force against changes in the volume of the laminate during charging and discharging.

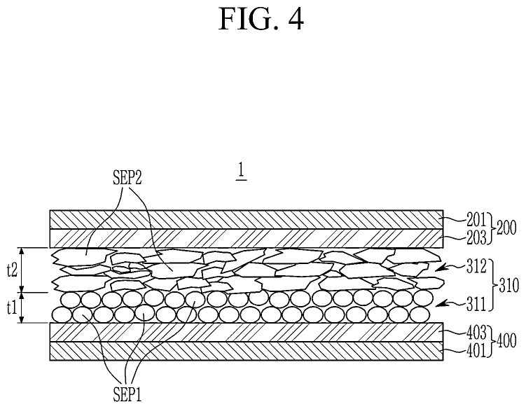

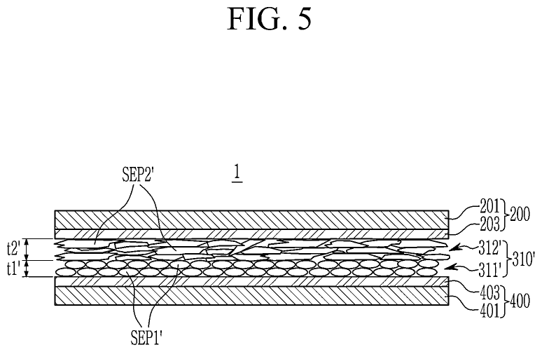

FIG. 4 is a longitudinal cross-sectional view showing the state before pressure is applied to the all-solid rechargeable battery, and FIG. 5 is a longitudinal cross-sectional view showing the state of the all-solid rechargeable battery of FIG. 4 after pressure is applied. Among the manufacturing processes of the all-solid rechargeable battery 1, there may be a process of pressing the laminate.

Before pressing the laminate, the first solid electrolyte layer 311 on the negative electrode 400 side of the solid electrolyte layer 310 may be formed with a first preliminary thickness t1, and the second solid electrolyte layer 312 on the positive electrode 200 side of the solid electrolyte layer 310 may be formed with a second preliminary thickness t2. The second preliminary thickness t2 may be greater than the first preliminary thickness t1 (e.g., t2>t1).

By applying pressure, the first and second preliminary thicknesses t1 and t2 of the first and second solid electrolyte layers 311 and 312 (see FIG. 4) may be respectively thinned to a first and second thicknesses t1′ and t2′ of the first and second solid electrolyte layers 311′ and 312′ (see FIG. 5). In an implementation, the first and second preliminary thicknesses t1 and t2 may be thinned to the first and second thicknesses t1′ and t2′ (t1>t1′, t2>t2′).

The first solid electrolyte layer 311 may have an average particle diameter (D50) of first solid electrolyte particles SEP1 of 10 nm to 10 μm, and may have the first preliminary thickness t1 of 50 μm to 100 μm, before pressure is applied. The second solid electrolyte layer 312 may have an average particle diameter (D50) of second solid electrolyte particles SEP2 of 10 nm to 10 μm, and may have the second preliminary thickness t2 of 25 μm to 50 μm before pressure is applied.

In an implementation, in the solid electrolyte layer 310, the first solid electrolyte layer 311 may include rounded first solid electrolyte particles SEP1 (see FIG. 4). After pressure is applied, the first solid electrolyte layer 311′ in the solid electrolyte layer 310′ may be on one surface of the negative electrode active material layer 403 and may have the first thickness t1′ of 2 μm or less (see FIG. 5). Rounded first solid electrolyte particles SEP1′ may enable uniform pressure even in the case of uniaxial pressure such as a roll press.

In an implementation, the first solid electrolyte layer 311 of the solid electrolyte layer 310 may include the first solid electrolyte particles SEP having, e.g., a spherical shape, an oval shape, and a disc shape. The spherical, oval, and disc-shaped first solid electrolyte particles SEP1 may help distribute the load even in the case of uniaxial pressure such as a roll press, thereby enabling more uniform pressure (see FIG. 4). After pressure is applied, the first solid electrolyte layer 311′ on one surface of the negative electrode active material layer 403 may have the first thickness t1′ of 2 μm or less (see FIG. 5). The spherical, oval, and disc-shaped first solid electrolyte particles SEP1′ may enable uniform pressure even in the case of uniaxial pressure such as roll press.

In an implementation, the second solid electrolyte layer 312 of the solid electrolyte layer 310 may include sharp type second solid electrolyte particles SEP2 (see FIG. 4). For example, the sharp type second solid electrolyte particles may have a sharp shape with sharp or rough edges. After pressure is applied, the second solid electrolyte layer 312′ on one surface of the negative electrode active material layer 403 may have the second thickness t2′ of 3 μm to 5 μm (see FIG. 5). The sharp type second solid electrolyte layer 312′ on the first solid electrolyte layer 311′ may enable uniform pressure together with the first solid electrolyte layer 311′.

In a state where uniform pressure is enabled by the first solid electrolyte layer 311, the sharp type second solid electrolyte particles SEP2′ may help disperse the load, even in the case of uniaxial pressure such as a roll press, thereby further enables uniform pressure.

The negative electrode active material layer 403 may include, e.g., a binder and a carbon layer of several tens of nm in size containing Ag powder of several tens of nm in size. The negative electrode active material layer 403 may be a tissue that is in a pre-press state but has a very weak physical bonding force.

In an implementation, the first solid electrolyte particles SEP1 of the first solid electrolyte layer 311 having the first preliminary thickness t1 may be pressurized against one axis, causing the thickness to decrease (t1>t1′) of the first solid electrolyte particles SEP1′ of the first solid electrolyte layer 311′, and the negative electrode active material layer 403 may not break. Therefore, a short circuit due to detachment of the negative electrode active material may be prevented.

Before and after pressure is applied, the first solid electrolyte layers 311 and 311′ may be on the negative electrode active material layer 403, and even if the second solid electrolyte particles SEP2 and SEP2′ are sharp type, they may not reach the negative electrode active material layer 403, thereby preventing damage to the negative electrode active material layer 403.

The first solid electrolyte particles SEP1 and SEP1′ facing the negative electrode active material layer 403 may have a small particle size and may form a soft powder (e.g., may be in powdered form) due to their round structure. The first solid electrolyte layers 311 and 311′ may include the first solid electrolyte particles SEP1 and SEP1′, and before pressure is applied, the first solid electrolyte particles SEP1 may be prepared in a wet process. The first solid electrolyte particles SEP1 and SEP1′ on the negative electrode 400 side may be prepared in a wet process to form fine particles with a smooth, rounded surface.

The second solid electrolyte particles SEP2 and SEP2′ facing the positive electrode active material layer 203 may have a large particle diameter and may form a sharp or coarse powder due to a sharp structure. The second solid electrolyte layers 312 and 312′ may include the second solid electrolyte particles SEP2 and SEP2′, and before pressure is applied, the second solid electrolyte particles SEP2 may be prepared in a dry process. The second solid electrolyte particles SEP2 and SEP2′ on the positive electrode 200 side may be prepared in a dry process to form large particles with a rough, sharp surface.

In an implementation, the first solid electrolyte layer 311 may be formed of rounded first solid electrolyte particles SEP1′ (see FIG. 4). In an implementation, after pressure is applied, the first solid electrolyte layer 311′ on one surface of the negative electrode active material layer 403 may have the first thickness t1′ of 0.5 μm to 1 μm (see FIG. 5).

In an implementation, the second solid electrolyte layer 312 may be formed of sharp type second solid electrolyte particles SEP2 (see FIG. 4). In an implementation, after pressure is applied, the second solid electrolyte layer 312′ on one surface of the negative electrode active material layer 403 may have the second thickness t2′ of 3 μm to 5 μm (see FIG. 5). The second thickness t2′ may be larger than the first′ thickness t1′ (t2>t1). The first solid electrolyte layers 311 and 311′ on the side of the negative electrode active material layer 403 may have first preliminary thickness t1 and the first thickness t1′, and may be have a minimum thickness to help prevent damage to the negative electrode active material layer 403.

The rechargeable battery 1 of the first embodiment may reduce usage of the second solid electrolyte particles SEP2 (having a rough surface prepared in a dry process) to help improve the performance of the battery, and may still partially use the first solid electrolyte particles SEP1. The performance of the first solid electrolyte particles SEP1 could be considered somewhat inferior, but may be prepared in a wet process and have a smooth surface, on the negative electrode 400 side. In an implementation, it is possible to help prevent the damage of the negative electrode 400 while minimizing the performance degradation of the rechargeable battery 10.

In an implementation, the first solid electrolyte particles SEP1 and SEP1′ may be in a powder form and have a rounded shape, may have small-diameter particles, may face the negative electrode active material layer 403, and the first solid electrolyte layer 311′ may have the first thickness t1′ of 0.5 μm to 1 μm after pressure is applied. The second solid electrolyte particles SEP2 and SEP2′ may be in a powder form that includes particles larger in diameter than the first solid electrolyte particles SEP1 and SEP1′, may face the positive electrode active material layer 203, and the second solid electrolyte layer 312′ may have the second thickness t2′ of 3 μm to 5 μm after pressure is applied. In an implementation, the negative electrode 400 may not be damaged after roll pressing. In an implementation, a short circuit due to detachment of the negative electrode active material may be prevented.

The rechargeable battery 1 of the first embodiment may help reduce or prevent the surface damage of the negative electrode active material layer 403 that could otherwise be caused by the solid electrolyte layer 310′, so physical defects may not occur on or at the interface between the solid electrolyte layer 310′ and the negative electrode active material layer 403. As a result, short circuits may not occur during charging and discharging, and long lifespan is possible.

Experimental examples applying the first solid electrolyte layers 311 and 311′ and the second solid electrolyte layers 312 and 312′ of the first embodiment will be described. Experimental Examples 1 to 7 confirmed the pressure uniformity, initial capacity, and short circuit occurrence time for the first solid electrolyte layers 311 and 311′ and the second solid electrolyte layers 312 and 312′.

In the first to third Comparative Examples, only the solid electrolyte layer corresponding to the second solid electrolyte layers 312 and 313′ was applied without applying the first solid electrolyte layers 311 and 311′, and confirmed the pressure uniformity, initial capacity, and short circuit occurrence time for the solid electrolyte layer. The solid electrolyte particle size is D50. In Comparative Examples 1 to 3, the first solid electrolyte particles, which were prepared in a wet process and including rounded, fine particles with a smooth surface, were not included on the negative electrode side.

TABLE 1

| | | Solid electrolyte layer | | | | | | | | |
|---|---|---|---|---|---|---|---|---|---|---|
| | | First layer (facing negative | | | Second layer (facing | | | | | |
| | | electrode) | | | positive electrode) | | | | | |
| | | | | Thickness | | | Thickness | Evaluation | | |
| | Negative | | Size | before | | Size | before | | Initial | Short circuit |
| | electrode | | (D50) | pressure | | (D50) | pressure | Pressure | capacity | occurrence |
| | Pre-press | Shape | (μm) | (μm) | shape | (μm) | (μm) | uniformity | (mAh/g) | time |
| First | Applied | Round | 0.5 | 50.0 | Sharp | 3.0 | 50.0 | Good | 190.0 | >200 |
| Experimental | | | | | | | | | | |
| Example | | | | | | | | | | |
| Second | Applied | round | 0.5 | 75.0 | Sharp | 3.0 | 25.0 | Good | 175.0 | >250 |
| Experimental | | | | | | | | | | |
| Example | | | | | | | | | | |
| Third | Applied | Round | 0.5 | 100.0 | — | — | — | Excellent | 150.0 | >300 |
| Experimental | | | | | | | | | | |
| Example | | | | | | | | | | |
| Fourth | Applied | Round | 1.0 | 50.0 | Sharp | 3.0 | 50.0 | Good | 175.0 | >180 |
| Experimental | | | | | | | | | | |
| Example | | | | | | | | | | |
| Fifth | Applied | Round | 1.0 | 75.0 | Sharp | 3.0 | 25.0 | Good | 165.0 | >250 |
| Experimental | | | | | | | | | | |
| Example | | | | | | | | | | |
| Sixth | Applied | Round | 1.0 | 100.0 | — | — | — | Good | 135.0 | >280 |
| Experimental | | | | | | | | | | |
| Example | | | | | | | | | | |
| Seventh | Not | Round | 0.5 | 50.0 | Sharp | 3.0 | 50.0 | Normal | 120.0 | >100 |
| Experimental | applied | | | | | | | | | |
| Example | | | | | | | | | | |
| First | Not | — | — | — | Square | 1.0 | 100.0 | Poor | 80.0 | <1 |
| Comparative | applied | | | | | | | | | |
| Example | | | | | | | | | | |
| Second | Not | — | — | — | Square | 3.0 | 100.0 | Poor | 50.0 | <1 |
| Comparative | applied | | | | | | | | | |
| Example | | | | | | | | | | |
| Third | Not | — | — | — | square | 5.0 | 100.0 | Poor | 20.0 | <1 |
| Comparative | applied | | | | | | | | | |
| Example | | | | | | | | | | |

The pre-press of the negative electrode active material layer 403 in the negative electrode 400 (Experimental Examples 1 to 6) was 1.5 (ton·f/cm) in line pressure, and room temperature (RT) was 25° C. In the positive electrode 200, the specific capacity of the positive electrode active material layer 203 was 200 (mAh/g), the positive electrode active material was 85%, the loading level (L/L) was 20.56 (mg/cm²), and the current density was 4.11 (mAh/cm²), and when pre-pressed, the line pressure was 5.0 (ton·f/cm) and the temperature was 120° C.

The negative electrode 400/solid electrolyte layer 300/positive electrode 200 were tack-welded. The diameter (φ) of the two rolls of the roll press were each 400×400 mm, the effective length was 120 mm, the line pressure was 5.0 (ton·f/cm), and the temperature was 120° C. The elastic layer 500 was made of acrylic foam or polyurethane foam and had a thickness of 300 μm, and was applied for charge/discharge evaluation. The initial capacity was 0.1 C-0.05 C charge and 0.1 C discharge, and the short circuit occurrence time was at 0.33 C-0.1 C charge and 0.33 C discharge.

Experimental Examples and Comparative Examples applied a high-temperature roll press to the manufacturing of an all-solid battery containing a sulfide solid electrolyte. The roll press was applied, and Experimental Examples and Comparative Examples showed the composition of the negative electrode 400 and the sulfide first solid electrolyte layers 311 and 311′ to prevent physical defects that may cause short circuits during charging and discharging on the interface of the negative electrode 400 and the first solid electrolyte layers 311 and 311′.

The Experimental Examples and Comparative Examples showed that, unlike conventional isostatic pressing, the pressure of a roll press in which lateral elongation was severe and shear acted on the film was, and it was difficult to achieve uniform pressure with conventional solid electrolyte powder and a single layer.

The Experimental Examples and Comparative Examples show that the state of the negative electrode 400 and the state of the first solid electrolyte layers 311 and 311′ may have certain characteristics in order for the two different layers to be physically pressed evenly.

The negative electrode 400 may be a carbon layer containing tens of nano-sized Ag particles, and the carbon layer may be very soft and vulnerable to scratches. Non-uniform Li precipitation could occur in the scratched area, causing a short circuit. Therefore, in the case of a roll press that is not isotropically pressed, a pre-press may be performed.

The first solid electrolyte layers 311 and 311′ including the rounded first solid electrolyte particles SEP1 and SEP1′ were applied to the first to seventh Experimental Examples, and the second solid electrolyte layers 312 and 312′ including the sharp type second solid electrolyte particles SEP2 and SEP2′ were applied to the first, second, fourth, fifth, and seventh Experimental Examples. In the first to third Comparative Examples, the first solid electrolyte layers 311 and 311′ were not applied, and a solid electrolyte layer of square electrolyte particles was applied.

Pre-press was not applied to the negative electrodes of the first to third Comparative Examples, and a normal coarse sulfide solid electrolyte powder was applied to the solid electrolyte layer. The first to third Comparative Examples had poor pressure uniformity, and due to this, it was difficult to evaluate normal charging and discharging.

In the first to sixth Experimental Examples, pre-press was applied to the negative electrode 400. In the seventh Experimental Example, pre-press was not applied to the negative electrode 400. The first solid electrolyte layers 311 and 311′ of the round type first solid electrolyte particles SEP1 and SEP1′ gently faced the negative electrode 400, pressure uniformity was appropriately shown. The properties of the powder itself of the first solid electrolyte layer 311 and 311′ were poor, the initial capacity was not high, but was superior to the first to third Comparative Examples.

In the first to sixth Experimental Examples, it may be seen that the pressure uniformity, initial capacity and the short circuit occurrence time were slightly different depending on the composition of the first solid electrolyte layers 311 and 311′ on the negative electrode 400 where pre-press is applied, e.g., depending on the first thicknesses t1 and t1′.

In the third and sixth Experimental Examples, the first solid electrolyte layers 311 and 311′ including the first solid electrolyte particles SEP1 and SEP1′, which were prepared in a wet process and including fine particles with a smooth, rounded surface, were disposed as a whole, and the second solid electrolyte layers 312 and 312′ including the second solid electrolyte particles, which were prepared in a dry process and including large particles with a rough, sharp surface, were not used.

The third and sixth Experimental Examples were prepared in a wet process, and by partially using smooth first solid electrolyte particles SEP1 and SEP1′, it was possible to prevent the damage of the negative electrode 400, maintain the performance of the all-solid rechargeable battery, and reduce physical defects inside the cell. The third and sixth Experimental Examples had excellent performance in terms of pressure uniformity, initial capacity, and short circuit occurrence time compared to the first to third Comparative Examples.

In the first, second, fourth, fifth and seventh Experimental Examples, the first solid electrolyte layers 311 and 311′ including the first solid electrolyte particles SEP1 and SEP1′, which were prepared in a wet process and including fine particles with a smooth, rounded surface, were on the negative electrode 400 side, and the second solid electrolyte layers 312 and 312′ including the second solid electrolyte particles SEP2 and SEP2′, which were prepared in a dry process and including large particles with a rough, sharp surface, were on the positive electrode 200 side.

The first, second, fourth, fifth, and seventh Experimental Examples reduced usage of the second solid electrolyte particles SEP2 and SEP2′ with a rough surface prepared in a dry process to improve the performance of the battery, but partially used the first solid electrolyte particles SEP1 and SEP1′, the performance of which was somewhat inferior but was prepared in a wet process and had a smooth surface. Therefore, it is possible to prevent the damage of the negative electrode 400, maintain the performance of the all-solid rechargeable battery 1, and reduce physical defects inside the cell.

Therefore, compared to the first to third Comparative Examples that did not including the first solid electrolyte layers 311 and 311′ including the first solid electrolyte particles SEP1 and SEP1′, the first, second, fourth, fifth, and seventh Experimental Examples had excellent performance in terms of pressure uniformity, initial capacity, and the short circuit occurrence time.

One or more embodiments may provide an all-solid rechargeable battery having differently formed first and second solid electrolyte layers on both sides between the negative electrode and the positive electrode.

In an embodiment, the first solid electrolyte particle prepared by a wet process and including fine particles with a smooth, rounded surface may be on the negative electrode side, and the second solid electrolyte particle prepared by a dry method and including large particles with a rough surface and sharp edges, may be on the positive electrode side.

An embodiment may reduce usage of the second solid electrolyte particles with a rough surface prepared in a dry process to help improve the performance of the battery, and may partially use the first solid electrolyte particles, the performance of which could be somewhat lower, but may be prepared in a wet process and may have a relatively smooth surface. Therefore, it is possible to prevent the damage of the negative electrode, maintain the performance of the all-solid rechargeable battery, and reduce physical defects inside the cell.

In this way, according to an embodiment, short circuit may be improved by reducing damage to the negative electrode and physical defects.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid rechargeable battery, comprising:
a negative electrode;
a first solid electrolyte layer on one surface of the negative electrode;
a second solid electrolyte layer on one surface of the first solid electrolyte layer; and
a positive electrode on one surface of the second solid electrolyte layer,
wherein:
the first solid electrolyte layer includes rounded first solid electrolyte particles, and
the first solid electrolyte layer has a first thickness of 2 μm or less.

2. The all-solid rechargeable battery as claimed in claim 1, wherein the rounded first solid electrolyte particles have a spherical shape, an oval shape, or a disc shape.

3. The all-solid rechargeable battery as claimed in claim 1, wherein
the second solid electrolyte layer includes second solid electrolyte particles, and
the second solid electrolyte particles have a sharp shape.

4. The all-solid rechargeable battery as claimed in claim 3, wherein the second solid electrolyte particles are in a powder form and are prepared by dry process.

5. The all-solid rechargeable battery as claimed in claim 1, wherein the rounded first solid electrolyte particles are in a powder form and are prepared by a wet process.

6. The all-solid rechargeable battery as claimed in claim 1, wherein:
the second solid electrolyte layer includes second solid electrolyte particles, and
the second solid electrolyte layer has a second thickness of 3 μm to 5 μm.

7. The all-solid rechargeable battery as claimed in claim 1, wherein the first thickness is 0.5 μm to 1 μm.

8. The all-solid rechargeable battery as claimed in claim 1, wherein:
the rounded first solid electrolyte particles have an average particle diameter (D50) of 10 nm to 10 μm, and
the first solid electrolyte layer has a thickness of 50 μm to 100 μm before pressure is applied thereto to form the first solid electrolyte layer having the first thickness of 2 μm or less.

9. The all-solid rechargeable battery as claimed in claim 8, wherein:
the second solid electrolyte layer includes second solid electrolyte particles,
the second solid electrolyte particles have an average particle diameter (D50) of 10 nm to 10 μm, and
the second solid electrolyte layer has a thickness of 25 μm to 50 μm before pressure is applied thereto.

10. The all-solid rechargeable battery as claimed in claim 1, wherein the second solid electrolyte layer has a second thickness that is greater than the first thickness.
